(19) United States
(12) Patent Application Publication
(10) Pub. No.: US 2008/0191439 A1
(43) Pub. Date: Aug. 14, 2008

(54) Vehicular steering apparatus

(75) Inventor: Wen-Chung Huang, Yung Kang City (TW)

Correspondence Address: POSZ LAW GROUP, PLC, 12040 SOUTH LAKES DRIVE, SUITE 101, RESTON, VA, 20191, US

(73) Assignee: Shih-Chang WU, Tainan City (TW)

(21) Appl. No.: 11/703,641

(22) Filed: Feb. 8, 2007

(51) Int. Cl. B62D 3/00

(52) U.S. Cl. 280/93.513

(57) ABSTRACT

A vehicular steering apparatus has a steering column connected to a steering wheel of a vehicle, a reduction gear mechanism and a pivot element. The reduction gear mechanism has a reduction gear assembly with a gear reduction for speed-power conversion, an input shaft connected between the reduction gear assembly and the steering column and an output shaft connected to the reduction gear assembly. The pivot element has a proximal end connected to the output shaft and a distal end connected to two tie rods of the vehicle. When the steering wheel is turned, the pivot element is pivoted with the transmission of the reduction gear mechanism to drive the tie rods to turn front wheels. The gear reduction provided by the reduction assembly converts a high rotational speed to a high torque such that the user can easily steer the steering column.

### BACKGROUND OF THE INVENTION

1. Field of the Invention

The present invention relates to a vehicular steering apparatus, and more particular to a vehicular steering apparatus which is more suitable for ATVs (All-Terrain Vehicles) or UVs (Utility Vehicles) and has improved performance in steerage to be easily steered.

2. Description of Related Art

ATVs (All-Terrain Vehicles) and UVs (Utility Vehicles) can be driven on particular terrain, e.g. beach, grass or the like for enjoyment or transportation.

Generally, an ATV or a UV runs on soft, lax or bumpy terrain, e.g. beach, grass, mud or the like, so wheels of the ATV or the UV sink more deeply into the ground than that of the ATV or the UV running on asphalt road. The wheels sinking into ground retard forward velocity of the ATV or the UV and are difficult to turn directions. Therefore, how to improve performance in steerage to make steering the vehicles become easier is an important subject.

A conventional steering apparatus for ATV has a steering column and a pivot element. The steering column has a bottom end. The pivot member is mounted securely at the bottom end of the steering column. Two tie rods of the ATV respectively have an inner end and an outer end. The inner ends of the tie rods are connected pivotally to the pivot element. The outer ends of the tie rods are respectively connected to two front wheels of the ATV. When a driver turns a steering wheel of the ATV, the steering column rotates the pivot element to drive the tie rods, such that the front wheels are respectively pushed and pulled by the tie rods and turn to a same direction to lead the ATV toward a desired direction.

However, the pivot element is directly driven by the steering column, so the driver has to strenuously turn the steering wheel to lead the ATV toward a desired direction. Additionally, the pivot element rotates simultaneously with the steering column, so an angle the steering wheels rotated directly and completely reacts to the pivot element. Therefore, a turning scale of the ATV does not have enough precision and the driver is hard to exactly steer the ATV toward a desired direction.

A conventional steering apparatus for UV has a steering column, a pinion gear and a drive rack. The steering column has a bottom end. The pinion gear is mounted securely at the bottom end of the steering column. The drive rack meshes with the pinion gear and has two ends and two ball joints. The ball joints are mounted respectively at the ends of the drive rack and are connected respectively to two inner ends, respectively of two tie rods. Two outer ends of the two tie rods are connected respectively to two front wheels of the UV. When a driver turns a steering wheel of the UV, the steering column rotates the pinion gear to drive the drive rack to move. Consequently, the front wheels are respectively pushed and pulled by the tie rods and turn to a same direction to lead the UV toward a desired direction.

The pinion gear and the rack meshed together are analogous to a reduction device such that the steering column can be rotated with less force. However, the ball joints provided at the ends of the drive rack are away from each other at a long distance substantially equal to a length of the drive rack, so the ball joints cause serious vibration when the drive rack drives the tie rods. The vibration feeds back to the steering column to decrease a turning precision of the UV and make the driver hard to exactly steer the UV toward a desired direction.

### SUMMARY OF THE INVENTION

The main objective of the present invention is to provide a vehicular steering apparatus to mitigate and obviate the aforementioned problems of the conventional steering apparatus.

The vehicular steering apparatus in accordance with the present invention has a steering column, a reduction gear mechanism and a pivot element. The steering column has a top end and a bottom end. The top end of the steering column is connected and rotates with a steering wheel of a vehicle. The reduction gear mechanism has a reduction gear assembly, an input shaft and an output shaft. The reduction gear assembly has a gear reduction for speed-power conversion. The input shaft is connected between the reduction gear assembly and the bottom end of the steering column. The output shaft is connected to the reduction gear assembly. When the steering wheel is turned, the steering column rotates to drive the input shaft and the output shaft is rotated with the transmission of the reduction gear assembly.

The pivot element has a proximal end and a distal end. The proximal end of the pivot element is connected to the output shaft such that the pivot element is capable of rotating with the output shaft. The distal end of the pivot element is connected to two tie rods of the vehicle. When the pivot element rotates, the tie rods are driven to turn front wheels of the vehicle to a same direction such that the user can steer the vehicle toward a desired direction easily.

The gear reduction provided by the reduction assembly converts a high rotational speed to a high torque that is needed for to easily steer the vehicle. Thus, the vehicle is easy to be exactly steered and has an improved performance in steerage. Further, the pivot element does not rotate simultaneously with the steering column, so the steering wheel needs to be rotated more angles to turn the front wheels to a specific angle than a conventional one and has a precise turning scale.

Additionally, two joints where the tie rods are mounted on the pivot element are closed, and the tie rods are connected to the pivot element without any universal joints. So, pivot element and the tie rods can keep stable when the vehicle is turned.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a vehicular steering apparatus in accordance with the present invention;

FIG. 2 is an enlarged side view in partial section of the vehicular steering apparatus in FIG. 1;

FIG. 3 is a perspective referenced view of a frame of a vehicle on which the vehicular steering apparatus in FIG. 1 is mounted;

FIG. 4 is an exploded perspective view of a second embodiment of a vehicular steering apparatus in accordance with the present invention; and

FIG. 5 is a perspective view of the vehicular steering apparatus in FIG. 4.

### DETAILED DESCRIPTION OF THE PREFERRED EMBODIMENT

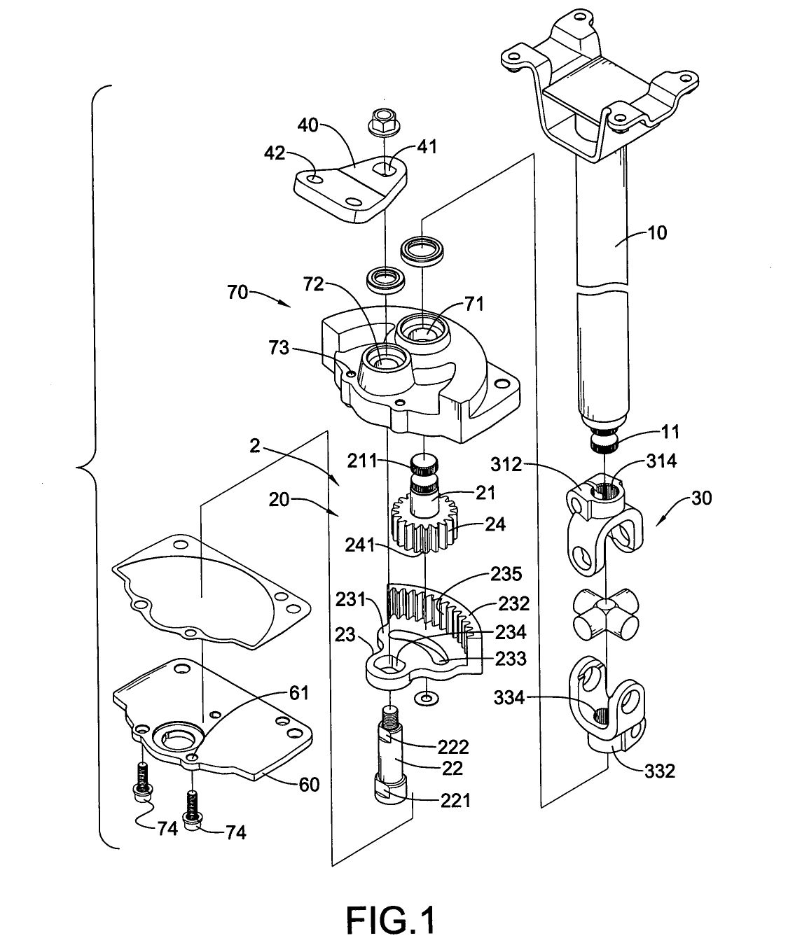

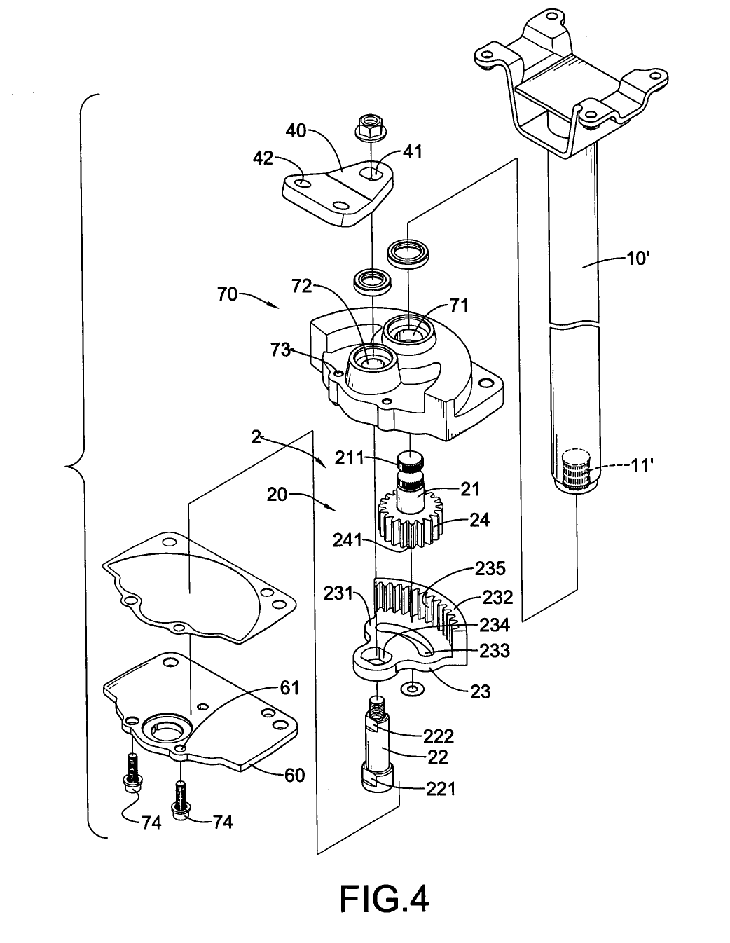

With reference to FIGS. 1, 2 and 4 a vehicular steering apparatus in accordance with the present invention comprises a steering column (10, 10′), a universal joint (30), a housing assembly, a reduction gear mechanism (2) and a pivot element (40).

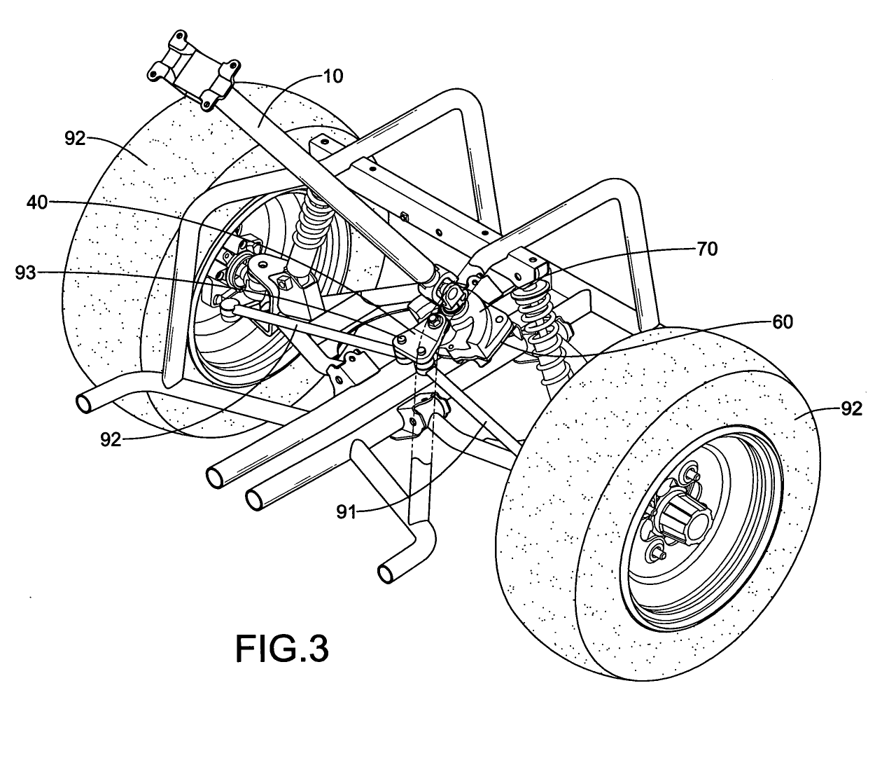

With further reference to FIG. 3, the steering column (10, 10′) has a top end and a bottom end. The top end of the steering column (10, 10′) is connected to and rotates simultaneously with a steering wheel of a vehicle. The bottom end of the steering column (10, 10′) has an outer surface and may be implemented in several ways.

In a first embodiment of the bottom end of the steering column (10), the bottom end of the steering column (10) has an outer thread (11). The outer thread (11) is formed on the outer surface of the bottom end of the steering column (10).

In a second embodiment of the bottom end of the steering column (10′), the bottom end of the steering column (10′) has a threaded connecting hole (11′). The threaded connecting hole (11′) is formed in the bottom end of the steering column (10′).

The universal joint (30) is mounted on the bottom end of the steering column (10) to absorb accidental impact to the steering column (10). The universal joint (30) has a top end (312), a bottom end (332), a top threaded hole (314) and a bottom threaded hole (334). The top threaded hole (314) is formed in the top end of the universal joint (30) and is screwed onto the outer thread (11) on the outer surface of the bottom end of the steering column (10). The bottom threaded hole (334) is formed in the bottom end of the universal joint (30).

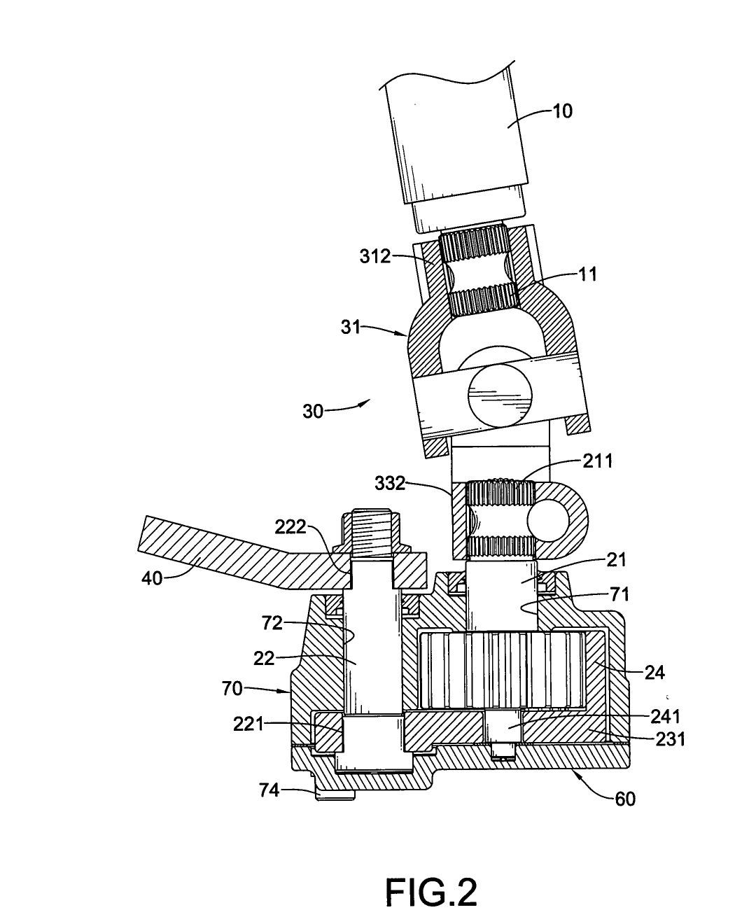

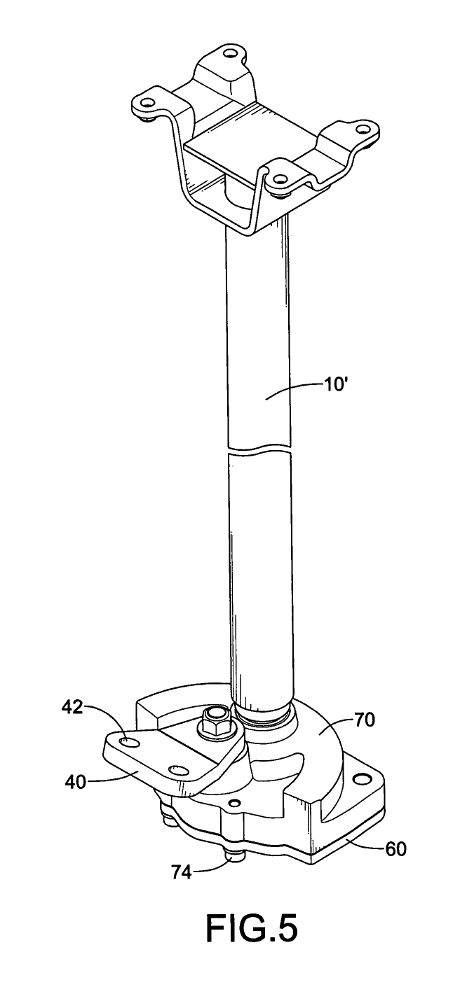

With further reference to FIGS. 2 and 5, the housing assembly is mounted under the steering column (10, 10′) and has a base board (60) and a cover (70). The base board (60) has multiple through holes (61). The through holes (61) are formed through the base board (60). The cover (70) is mounted on the base board (60) and has an input shaft hole (71), an output shaft hole (72), multiple through holes (73) and multiple fasteners (74). The input shaft hole (71) is formed through the cover (70). The output shaft hole (72) is formed through the cover (70). The through holes (73) are formed through the cover (70). The fasteners (74) are mounted through the through holes (61) in the base board (60) and the through holes (73) in the cover (70) to securely mount the cover (70) on the base board (60).

The reduction gear mechanism (2) has a reduction gear assembly (20), an input shaft (21) and an output shaft (22) and may be mounted in the housing assembly. The reduction gear assembly (20) has a gear reduction for speed-power conversion and may be implemented with an internal gear element (23) and a drive gear (24).

The internal gear element (23) has a base panel (231) and a curved flange (232). The base panel (231) has an outer edge a curved slot (233) and a drive hole (234) and may be fan-shaped. The curved slot (233) is formed through the base panel (231). The drive hole (234) is formed through the base panel (231) and is non-circular, e.g. hexagonal, elliptic or the like. The curved flange (232) is formed on and protrudes up from the outer edge of the base panel (231), is homocentric with the curved slot (233), has a toothed inner surface (235) and may be opposite to the drive hole (234) across the curved slot (233).

The drive gear (24) is mounted rotatably on and connected slidably to the base panel (231) of the internal gear element (23), meshes with the toothed inner surface (235) on the curved flange (232) and has a top, a bottom and a limit rod (241). The limit rod (241) is coaxially formed on and protrudes down form the bottom of the drive gear (24) and is mounted moveably in the curved slot (233) in the base panel (231) of the internal gear element (23) such that relative rotation between the drive gear (24) and the toothed inner surface (235) on the curved flange (232) is allowable to provide the gear reduction for speed-power conversion.

The input shaft (21) is connected between the reduction gear assembly (20) and the bottom end of the steering column (10, 10′) to be driven by the steering column (10, 10′) and transmit mechanical power to the reduction gear assembly (20). The input shaft (21) has a top end and a bottom end. The top end of the input shaft has an outer surface and an outer thread (211). The outer thread (211) is formed on the outer surface of the top end of the input shaft (21) and may be screwed into the bottom threaded hole (334) in the bottom end (332) of the universal joint (30) mounted on the bottom end of the steering column (10) or be screwed into the threaded connecting hole (11′) formed in the bottom end of the steering column (10′) to connected the input shaft (21) between the reduction gear assembly (20) and the bottom end of the steering column (10, 10′).

Additionally, the bottom end of the input shaft (21) may be coaxially formed on and protrude up from the top of the drive gear (24) and extend through the input shaft hole (71) in the cover (70).

The output shaft (22) is connected to the reduction gear assembly (20) to receive and transmit mechanical power from the reduction gear assembly (20), has a top end (222) and a bottom end (221) and may be mounted securely on the base panel (231) of the internal gear element (23). The top end (222) of the output shaft (22) may extend through the output shaft hole (72) in the cover (70) and have a non-circular cross-section. The bottom end (221) of the output shaft (22) may have a non-circular cross-section corresponding to and mounted securely in the drive hole (234) in the base panel (231) of the internal gear element (23) to mount the output shaft (22) securely on the internal gear element (23). Thus, the output shaft (22) rotates relative to the input shaft (21) when the drive gear (24) rotates.

The pivot element (40) has a proximal end, a distal end, a mounting hole (41) and two connecting holes (42). The proximal end of the pivot element (40) is connected to and driven by the output shaft (22). The distal end of the pivot element (40) is connected pivotally with two inner ends, respectively of two tie rods (91) to drive the tie rods (91).

The mounting hole (41) is formed through the proximal end of the pivot element (40) and is non-circular and corresponding to the non-circular cross-section of the top end (222) of the output shaft (22) to securely hold the top end (222) of the output shaft (22). Thus, the pivot element (40) rotates relative to the input shaft (21) when the internal gear element (23) rotates relative to the drive gear (24). The connecting holes (42) are formed through the distal end of the pivot element (40) at an interval and are respectively connected to the inner ends of the tie rods (91) through fastening elements (93).

Two outer ends of the two tie rods (91) are connected respectively to two front wheel (92) of the vehicle.

When a driver turns the steering wheel of the UV, the steering column (10, 10′) rotates the input shaft (21) and transmits mechanical power to rotate the output shaft (22) with the transmission of the reduction gear assembly (20) and the tie rods (91) are driven. Thus, the front wheels (92) are respectively pushed and pulled by the tie rods (91) and turn to a same direction to lead the vehicle toward a desired direction.

The reduction gear assembly (20) provides a significant speed-power conversion known as gear reduction to output a higher torque to rotate the pivot element (40) for driving the tie rods (91). Therefore, a performance in steerage of the vehicle is improved and the user can turn the steering wheel to turn the front wheels (92) toward a desired direction easily.

Additionally, the pivot element (40) does not rotate simultaneously with the steering column (10, 10′) so a turning scale of the vehicle is precise and allows the driver to exactly steer the ATV toward a desired direction.

Furthermore, the inner ends of the tie rods (91) are close to each other so that the pivot element (40) to which the tie rods (91) connected can keep stable when the vehicle turns directions to improve a turning precision and make the driver able to exactly steer the vehicle.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vehicular steering apparatus comprising
a steering column having
a top end; and
a bottom end having an outer surface;
a reduction gear mechanism having
a reduction gear assembly having a gear reduction for speed-power conversion;
an input shaft connected between the reduction gear assembly and the bottom end of the steering column and having
a top end having an outer surface; and
a bottom end; and
an output shaft connected to the reduction gear assembly and having
a top end; and
a bottom end; and
a pivot element having
a proximal end connected to the output shaft; and
a distal end.

2. The vehicular steering apparatus as claimed in claim 1, wherein
the reduction gear assembly is implemented with
an internal gear element having
a base panel having
an outer edge; and
a curved slot formed through the base panel; and
a curved flange formed on and protruding up from the outer edge of the base panel, being homocentric with the curved slot and having a toothed inner surface; and
a drive gear mounted rotatably on and connected slidably to the base panel of the internal gear element, meshing with the toothed inner surface on the curved flange and having
a top;
a bottom; and
a limit rod coaxially formed on and protruding down form the bottom of the drive gear and mounted slidably in the curved slot in the base panel of the internal gear element;
the bottom end of the input shaft is coaxially formed on and protrudes up from the top of the drive gear; and
the output shaft is mounted securely on the base panel of the internal gear element.

3. The vehicular steering apparatus as claimed in claim 2, wherein
the base panel further has a drive hole formed through the base panel and being non-circular;
the curved flange is opposite to the drive hole across the curved slot;
the bottom end of the output shaft has a non-circular cross-section corresponding to and mounted securely in the drive hole in the base panel of the internal gear element;
the top end of the output shaft have a non-circular cross-section; and
the pivot element further has a mounting hole formed through the proximal end of the pivot element, being non-circular and corresponding to the non-circular cross-section of the top end of the output shaft to securely hold the top end of the output shaft.

4. The vehicular steering apparatus as claimed in claim 3, wherein
the bottom end of the steering column further has an outer thread formed on the outer surface of the bottom end of the steering column;
the vehicular steering apparatus further has a universal joint mounted on the bottom end of the steering column and having
a top end;
a bottom end;
a top threaded hole formed in the top end of the universal joint and screwed onto the outer thread on the outer surface of the bottom end of the steering column; and
a bottom threaded hole formed in the bottom end of the universal joint; and
the top end of the input shaft further has an outer thread formed on the outer surface of the top end of the input shaft and screwed into the bottom threaded hole in the bottom end of the universal joint.

5. The vehicular steering apparatus as claimed in claim 3, wherein
the bottom end of the steering column has a threaded connecting hole formed in the bottom end of the steering column; and
the top end of the input shaft further has an outer thread formed on the outer surface of the top end of the input shaft and screwed into the threaded connecting hole in the bottom end of the steering column.

6. The vehicular steering apparatus as claimed in claim 3, wherein the base panel of the internal gear element is fan-shaped.

7. The vehicular steering apparatus as claimed in claim 3, wherein
the vehicular steering apparatus further has a housing assembly mounted under the steering column and having
a base board; and
a cover mounted on the base board and having
an input shaft hole formed through the cover; and
an output shaft hole formed through the cover;
the reduction gear mechanism is mounted in the housing assembly;
the bottom end of the input shaft extends through the input shaft hole in the cover; and
the top end of the output shaft extends through the output shaft hole in the cover.
